(19) United States
(12) Patent Application Publication
(10) Pub. No.: US 2026/0255138 A1
(43) Pub. Date: Aug. 27, 2026

(54) APPARATUS AND METHOD FOR VEHICLE EXTERNAL COMMUNICATION

(71) Applicants: Hyundai Motor Company, Seoul (KR); Kia Corporation, Seoul (KR)

(72) Inventor: Seung Woo Lee, Hwaseong (KR)

(21) Appl. No.: 19/286,877

(22) Filed: Jul. 31, 2025

(30) Foreign Application Priority Data
Feb. 24, 2025 (KR) 10-2025-0023491

(51) Int. Cl. H04W 4/44; E05F 15/73; G06T 7/70; H04N 7/18; H04R 1/40; H04R 3/00

(52) U.S. Cl. CPC H04W 4/44; E05F 15/73; G06T 7/70; H04N 7/183; H04R 1/406; H04R 3/005; E05F 2015/763; E05F 2015/767; E05Y 2400/816; E05Y 2900/55; G06T 2207/30196; G06T 2207/30252; H04R 2430/01; H04R 2499/13

(57) ABSTRACT

The present disclosure relates to an apparatus and method for a vehicle external communication. An apparatus for a vehicle external communication according to the present disclosure comprises a processor configured to generate location information of a user through an external sensor of a vehicle; control a window of the vehicle based on the location information of the user; process respective voice signals transmitted from a plurality of microphones inside the vehicle based on the location information of the user; and output a guidance voice through a speaker closest to the user among a plurality of speakers based on the location information of the user.

### CROSS-REFERENCE TO RELATED APPLICATION(S)

This present application claims, under 35 U.S.C. §119(a), the benefit of Korean Patent Application No. 10-2025-0023491, entitled “APPARATUS AND METHOD FOR VEHICLE EXTERNAL COMMUNICATION,” filed on Feb. 24, 2025, in the Korean Intellectual Property Office, the entire contents of which are incorporated herein by reference.

### BACKGROUND

### (a) Technical Field

The present disclosure relates to an apparatus and method for vehicle external communication and, more specifically, to an apparatus and method configured to enable a user outside a vehicle to communicate through a microphone and a speaker inside the vehicle.

### (b) Description of the Related Art

Recently, technological development has been in progress for autonomous vehicles that transport passengers to their destinations. A representative example is a robotaxi, which is an autonomous vehicle capable of transporting passengers from a pick-up location to a desired destination solely through autonomous driving, without a separate driver's seat or driver.

In general, a standard procedure for a robotaxi service may include requesting a vehicle through a digital key application and commanding door unlocking via the application to a server when the robotaxi arrives. However, there have been cases in which it has been difficult to use a robotaxi due to digital key authentication errors, even when a valid digital key is used, or when a terminal with the digital key application is discharged, making it impossible to authenticate a passenger.

An external interface such as, e.g., a physical button, an external speaker, and/or an external microphone have been added to robotaxis, enabling passengers to press a call button installed on the robotaxi and make a voice call with a guide at an external control server when a smartphone is discharged after calling the robotaxi. However, this approach increases hardware manufacturing costs and development complexity and is vulnerable to interference from external noise during calls. In particular, when a physical button is used, additional maintenance, such as cleanliness and fault management, is required, and forcing passengers to move to a side of the robotaxi to access the physical button, thereby degrading a user experience. Furthermore, since additional external hardware components are required, this approach is also disadvantageous in terms of the robotaxi's vehicle design.

### SUMMARY

The present disclosure is directed to providing an apparatus and method for vehicle external communication that enable a user to communicate with an external control server by utilizing a microphone, a speaker, and a communication unit provided in a vehicle.

In addition, the present disclosure is directed to providing an apparatus and method for vehicle external communication that enable a user to communicate with an external control server by utilizing hardware implemented in existing vehicles, such as an around-view camera, an interior speaker, and an interior microphone.

Further, the present disclosure is directed to providing an apparatus and method for vehicle external communication that enable a user to communicate with an external control server via the vehicle by utilizing an around-view system, a microphone beamforming control technology, and a speaker output logic.

According to an object of the present disclosure, an apparatus for vehicle external communication is provided. The apparatus may comprise a processor configured to generate location information of a user through an external sensor of a vehicle, control a window of the vehicle based on the location information of the user, process respective voice signals transmitted from a plurality of microphones inside the vehicle based on the location information of the user, and output a guidance voice through a speaker closest to the user among a plurality of speakers based on the location information of the user.

According to an exemplary embodiment of the present disclosure, the processor may be configured to receive distance information between the vehicle and surrounding objects through an ultrasonic sensor, capture an image of one or more of a front, a rear, a left side, or a right side of the vehicle through a camera, detect the user based on the distance information and the image, and generate location information of the user based on the distance information and the image, wherein the location information comprises a user's distance and direction relative to the vehicle, and the direction is one of a front-left, a front-right, a rear-left, or a rear-right of the vehicle.

According to an exemplary embodiment of the present disclosure, the processor may be configured to detect a user area based on the distance information and the image through a single shot detector (SSD), determine a confidence score for each of the detected user areas, and determine the user based on the user area with a highest confidence score among user areas having confidence scores equal to or greater than a predetermined threshold.

According to an exemplary embodiment of the present disclosure, the processor may be configured to control opening or closing of the window in the direction of the user through a body domain controller (BDC) based on a communication request signal of the user received through an in-vehicle infotainment (IVI) system connected to an external control server.

According to an exemplary embodiment of the present disclosure, the processor may be configured to adjust an opening degree of the window in the direction of the user through the BDC based on the user's distance relative to the vehicle.

According to an exemplary embodiment of the present disclosure, the guidance voice may comprise one or more of a hands-free sound output through a call connection with the external control server or a guidance voice of the IVI system output in response to the voice signal of the user.

According to an exemplary embodiment of the present disclosure, the processor may be configured to close the window through the BDC, capture an interior image of the vehicle through an interior camera via the IVI system, and transmit the interior image of the vehicle to the external control server, based on one or more of a communication termination signal being received from a terminal of the user, a communication termination signal being received from the external control server, or the user not being determined.

According to an exemplary embodiment of the present disclosure, the processor may be configured to adjust a beamforming region of the plurality of microphones to a region covering the user based on the location information of the user, and extract a voice signal corresponding to the beamforming region.

According to an exemplary embodiment of the present disclosure, the processor may be configured to perform one or more of noise suppression, auto gain control (AGC), equalization, or digital filtering on a voice signal of the user.

According to an exemplary embodiment of the present disclosure, the processor may be configured to set a gain value of an external amplifier based on the user's distance relative to the vehicle.

According to an object of the present disclosure, a system for vehicle external communication is provided. The system may comprise a vehicle and a computing device. The computing device may be coupled to the vehicle. The computing device may comprises a processor and a memory. The memory may be configured to store instructions that, when executed by the processor, are configured to cause the processor to generate location information of a user through an external sensor of the vehicle, control a window of the vehicle based on the location information of the user, process respective voice signals transmitted from a plurality of microphones inside the vehicle based on the location information of the user, and output a guidance voice through a speaker closest to the user among a plurality of speakers based on the location information of the user.

According to an object of the present disclosure, a method for vehicle external communication is provided. The method may comprise, using a computing device, coupled to a vehicle, comprising a processor and a memory, generating location information of a user through an external sensor of the vehicle, controlling a window of the vehicle based on the location information of the user, processing respective voice signals transmitted from a plurality of microphones inside the vehicle based on the location information of the user, and outputting a guidance voice through a speaker closest to the user among a plurality of speakers based on the location information of the user.

According to an exemplary embodiment of the present disclosure, the generating the location information of the user may comprise receiving distance information between the vehicle and surrounding objects through an ultrasonic sensor, capturing an image of one or more of a front, a rear, a left side, or a right side of the vehicle through a camera, detecting the user based on the distance information and the image, and generating the location information of the user based on the distance information and the image, wherein the location information comprises a user's distance and direction relative to the vehicle, and the direction is one of a front-left, a front-right, a rear-left, or a rear-right of the vehicle.

According to an exemplary embodiment of the present disclosure, the generating the location information may comprise detecting a user area based on the distance information and the image through a single shot detector (SSD), determining a confidence score for each of the detected user areas, and determining the user based on the user area with a highest confidence score among user areas having confidence scores equal to or greater than a predetermined threshold.

According to an exemplary embodiment of the present disclosure, the controlling may comprise controlling opening or closing of the window in the direction of the user through a body domain controller (BDC) based on a communication request signal of the user received from in-vehicle infotainment (IVI) system connected to an external control server.

According to an exemplary embodiment of the present disclosure, the controlling may comprise adjusting an opening degree of the window in the direction of the user through the BDC based on the user's distance relative to the vehicle.

According to an exemplary embodiment of the present disclosure, the controlling may comprise closing the window through the BDC, capturing an interior image of the vehicle through an interior camera via the IVI system, and transmitting the interior image of the vehicle to the external control server, based on one or more of a communication termination signal being received from a terminal of the user, a communication termination signal being received from the external control server, or the user not being determined.

According to an exemplary embodiment of the present disclosure, the guidance voice may comprise one or more of a hands-free sound output through a call connection with the external control server or a guidance voice of the IVI system output in response to the voice signal of the user.

According to an exemplary embodiment of the present disclosure, the method may comprise adjusting a beamforming region of the plurality of microphones to a region covering the user based on the location information of the user, and extracting a voice signal corresponding to the adjusted beamforming region.

According to an exemplary embodiment of the present disclosure, the extracting the voice signal may comprise performing one or more of noise suppression, auto gain control (AGC), equalization, or digital filtering on a voice signal of the user.

According to an exemplary embodiment of the present disclosure, the outputting the guidance voice may comprise setting a gain value of an external amplifier based on the user's distance relative to the vehicle.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram illustrating a vehicle external communication apparatus according to an exemplary embodiment of the present disclosure.

FIG. 2 is a flowchart illustrating a vehicle external communication method according to an exemplary embodiment of the present disclosure.

FIG. 3 is a diagram illustrating opening and closing positions of a window according to an exemplary embodiment of the present disclosure.

FIG. 4 is a diagram illustrating a processing of sensor data through a single shot detector (SSD) algorithm to generate location information of a user according to an exemplary embodiment of the present disclosure.

FIG. 5 is a diagram illustrating processing of respective voice signals transmitted from a plurality of microphones inside the vehicle based on location information of a user according to an exemplary embodiment of the present disclosure.

FIG. 6 illustrates an example architecture of a vehicle, according to an exemplary embodiment of the present disclosure.

FIG. 7 illustrates example elements of a computing device, according to an exemplary embodiment of the present disclosure.

### DETAILED DESCRIPTION

Hereinafter, the exemplary embodiment of the present disclosure will be described in detail. This exemplary embodiment is implemented based on the technical solution of the present disclosure, and shows a specific implementation method and a specific operation process, but the protection scope of the present disclosure is not limited to the exemplary embodiment below.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, exemplary embodiments of the present disclosure will be described in detail with reference to the attached drawings.

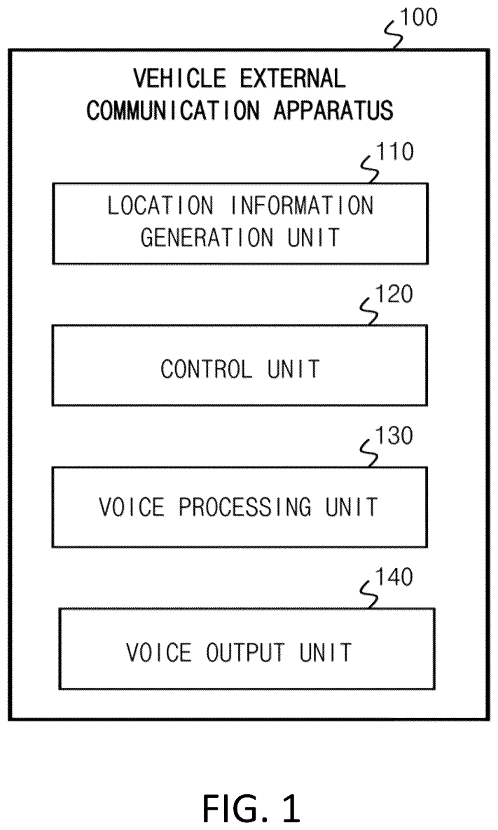

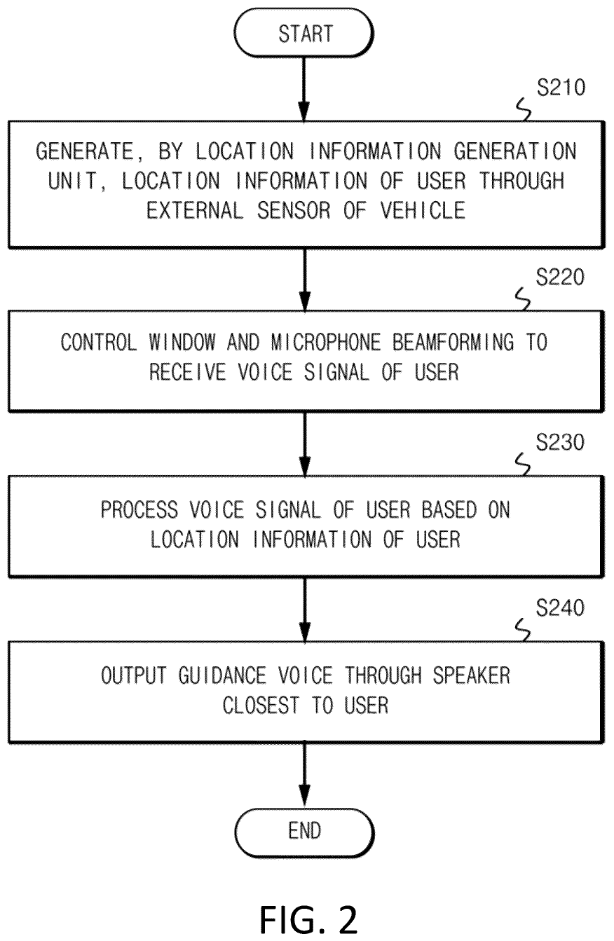

FIG. 1 is a block diagram of a vehicle external communication apparatus according to one embodiment of the present disclosure, and FIG. 2 is a flowchart of a vehicle external communication method according to one embodiment of the present disclosure.

Referring now to FIG. 1, a vehicle external communication apparatus 100 is illustratively depicted, in accordance with an exemplary embodiment of the present disclosure.

According to an exemplary embodiment, the vehicle external communication apparatus 100 may comprise a location information generation unit 110, a control unit 120, a voice processing unit 130, a voice output unit 140, and/or other suitable components.

The location information generation unit 110 may be configured to detect a user and determine a user's direction relative to a vehicle (e.g., vehicle system architecture 600) based on a 2-Dimensional (2D) image acquired through a camera provided outside the vehicle, and to determine the user's distance relative to the vehicle based on depth information acquired through a distance sensor provided outside the vehicle, thereby generating location information of the user including the user's direction and distance (see, e.g., S210 of FIG. 2). According to an exemplary embodiment, the camera and/or the distance sensor may be coupled to the vehicle.

According to an exemplary embodiment, the location information generation unit 110 may be configured to detect the user through, e.g., an ultrasonic sensor and the camera, and generate information about the user's direction and distance based on the detected user. For example, the location information generation unit 110 may be configured to acquire distance information from the vehicle to one or more surrounding objects through the ultrasonic sensor, and acquire an image of at least one of a front, a rear, a left side, or a right side of the vehicle through the camera. For example, the location information generation unit 110 may be configured to detect the user based on the distance information from the vehicle to one or more surrounding objects and the image.

Accordingly, the location information generation unit 110 may be configured to generate the location information of the user, including the user's distance and direction relative to the vehicle, based on the distance information from the vehicle to one or more surrounding objects and the image.

The user's direction may be set to one of a front-left, front-right, rear-left, or rea r-right side of the vehicle, and/or may be set as a direction toward the user from a center point of positions where a plurality of microphones are installed inside the vehicle.

Meanwhile, the location information generation unit 110 may be configured to detect a user area based on the distance information and the image through a single shot detector (SSD), determine a confidence score for each of the detected user areas, and identify the user based on the user area with a highest confidence score among user areas having confidence scores equal to or greater than a predetermined threshold. For example, the location information generation unit may be configured to identify the user through a processor implemented to perform object detection using a SSD.

According to an exemplary embodiment, the confidence score may have a value between 0 and 1, and the closer the confidence score value is to 1, the higher the likelihood that the corresponding user region actually includes the user.

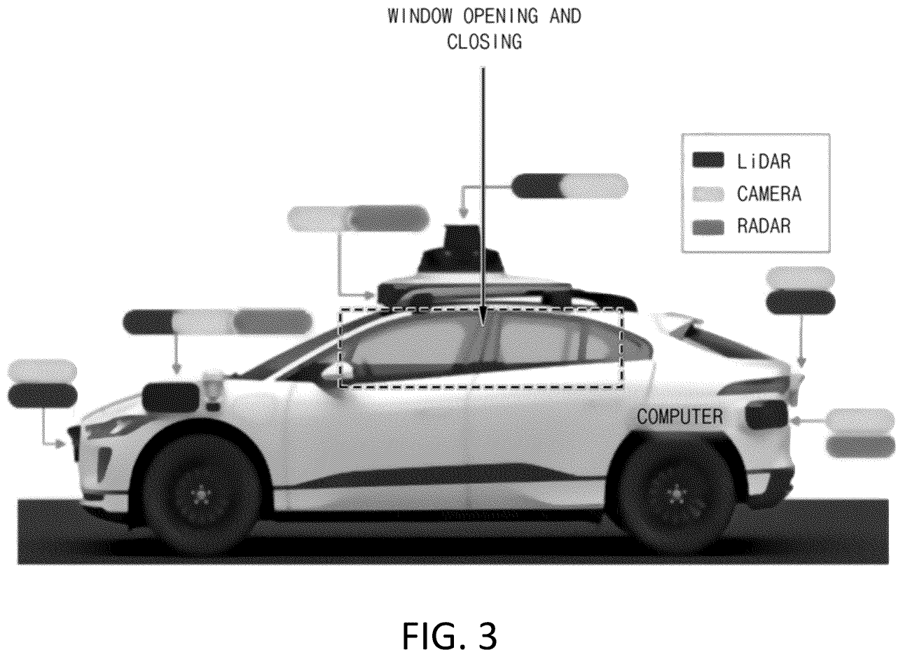

Referring now to FIG. 3, opening and closing positions of a window are illustratively depicted, in accordance with an exemplary embodiment of the present disclosure.

According to an exemplary embodiment, a vehicle external communication apparatus may be configured to process a voice signal based on a user's location, and therefore does not constrain the user's location.

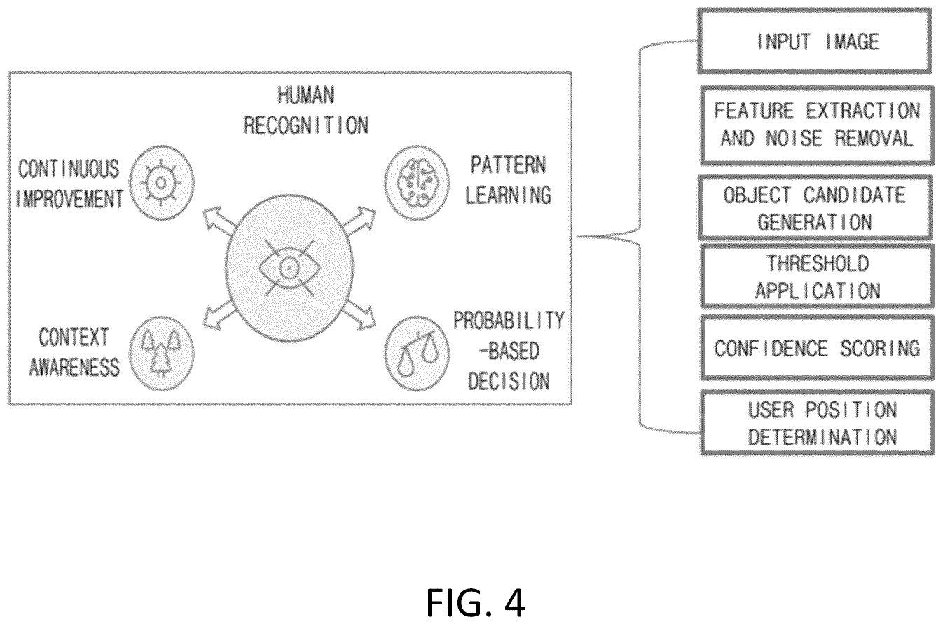

Referring now to FIG. 4, a processing of sensor data through a single shot detector (SSD) algorithm to generate location information of a user is illustratively depicted, in accordance with an exemplary embodiment of the present disclosure.

According to an exemplary embodiment, the SSD may comprise an algorithm that is configured to detect the presence of one or more objects and determine their locations within an image or video frame. The SSD may be configured to perform feature extraction and noise reduction on an input image, select candidate object regions in which the probability of the presence of an object around the vehicle exceeds a predetermined threshold, assign a confidence score based on the probability that the selected candidate object region actually includes the user, and determine the user's location based on the assigned confidence score.

The control unit 120 may be configured to control a window of the vehicle based on the location information of the user (see, e.g., S220 of FIG. 2). For example, the control unit 120 may be configured to open the window in the direction of the user when an external communication execution signal is received from an external control server. Specifically, the control unit may be configured to control opening or closing of the window in the direction of the user through a body domain controller (BDC) when an in-vehicle infotainment (IVI) system receives a communication request signal of the user from an external control server.

In addition, the control unit 120 may be configured to adjust an opening degree of the window through the BDC based on the user's distance relative to the vehicle.

In addition, the control unit 120 may be configured to control a body domain including, e.g., a door lifting controller, a window lifting controller, an electric side mirror, an air conditioner, a central door lock, and the like through the BDC implemented as an ECU.

For example, the control unit 120 may be configured to generate a control signal for a motor driver of an actuator based on a position sensor monitoring the position of the window, and may be implemented to adjust the opening and closing amount of a specific window.

For example, the control unit 120 may be configured to partially open the window with a lower degree of opening as the detected user's distance relative to the vehicle becomes shorter.

Accordingly, vehicle security and stability may be enhanced, speaker output efficiency may be improved, and the interior temperature may be maintained more effectively through air conditioning and heating.

On the other hand, the control unit 120 may be configured to increase an opening degree of the window as the detected user's distance relative to the vehicle becomes greater. Accordingly, the voice recognition rate of the microphone may be improved, and the output efficiency of the speaker may be increased.

The voice processing unit 130 may be configured to process respective voice signals transmitted from a plurality of microphones inside the vehicle based on the location information of the user (see, e.g., S230 of FIG. 2). For example, the voice processing unit 130 may be configured to receive voice signals only from the user's direction, and may be configured to remove voice signals or noise from other directions. For example, the voice processing unit 130 may be configured to adjust a beamforming region of the plurality of microphones to a region covering the user based on the location information of the user and extract a voice signal corresponding to the beamforming region.

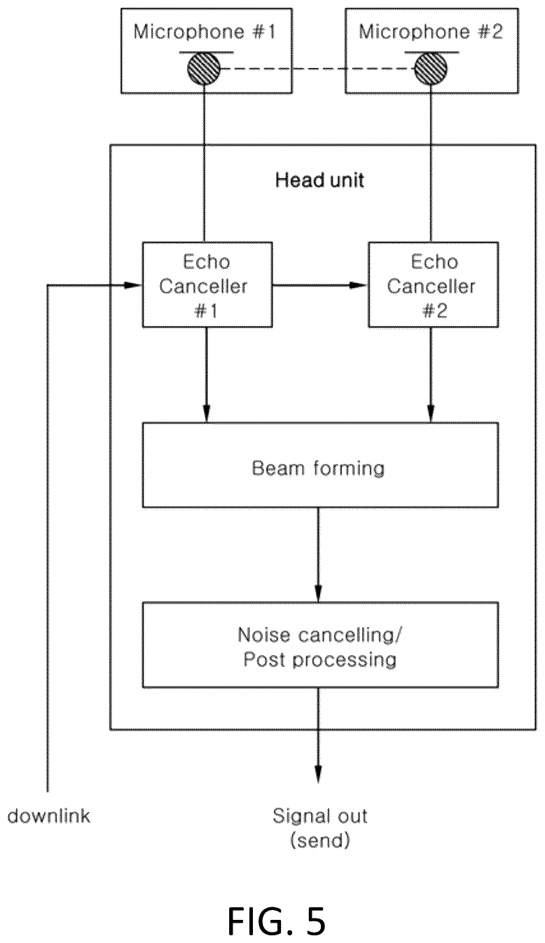

Referring now to FIG. 5 a diagram illustrating processing of respective voice signals transmitted from a plurality of microphones inside the vehicle based on location information of a user is illustratively depicted, in accordance with an exemplary embodiment of the present disclosure.

According to an exemplary embodiment, the voice processing unit 130 may be configured to perform echo cancellation (Echo Canceller #1, Echo Canceller #2), respectively, on respective voice signals transmitted from microphones (Microphone #1, Microphone #2), based on the location information of the user and vehicle control information received via downlink through a head unit. Thereafter, the voice processing unit 130 may be configured to perform beam-forming processing on the echo-cancelled voice signals. Then, the voice processing unit 130 may be configured to perform noise-cancelling processing and post-processing on the beam-formed voice signals.

For example, when performing post-processing, the voice processing unit 130 may be configured to reduce residual noise and distortion, and enhance signals in specific frequency bands such as, e.g., voice.

For example, the voice processing unit 130 may be configured to perform at least one of noise suppression, auto gain control (AGC), equalization, or digital filtering on a voice signal of the user.

The voice output unit 140 may be configured to output a guidance voice through a speaker closest to the user among the plurality of speakers based on the location information of the user (see, e.g., S240 of FIG. 2). For example, when a position of the user is determined to be at the front left side of the vehicle, the voice output unit 140 may be configured to output a guidance voice through a speaker disposed at the front left door of the vehicle.

In addition, the voice output unit 140 may be configured to set a gain value of an external amplifier based on the user's distance relative to the vehicle.

For example, the voice output unit 140 may be configured to increase the sound output level as the user's distance relative to the vehicle increases.

According to an exemplary embodiment, the guidance voice may comprise at least one of a hands-free sound output through a call connection with the external control server or a guidance voice of the IVI system output in response to the voice signal of the user.

For example, a vehicle external communication apparatus according to an exemplary embodiment of the present disclosure may be configured to allow the user to make a call with an operator by connecting to the external control server, perform user authentication through the external control server, or control the vehicle.

On the other hand, a vehicle external communication apparatus according to an exemplary embodiment of the present disclosure may be configured to allow the user to perform user authentication or control the vehicle through the vehicle itself without connecting to the external control server.

The control unit 120 may be configured to close the window through the BDC, capture an interior image of the vehicle through an interior camera via the IVI system, and transmit the interior image of the vehicle to the external control server, based on at least one of a communication termination signal being received from a terminal of the user, a communication termination signal being received from the external control server, or the user not being identified.

According to an exemplary embodiment, when a logic for terminating the communication operation as described above is applied, contamination and damage to the vehicle may be prevented, thereby enhancing vehicle security and safety.

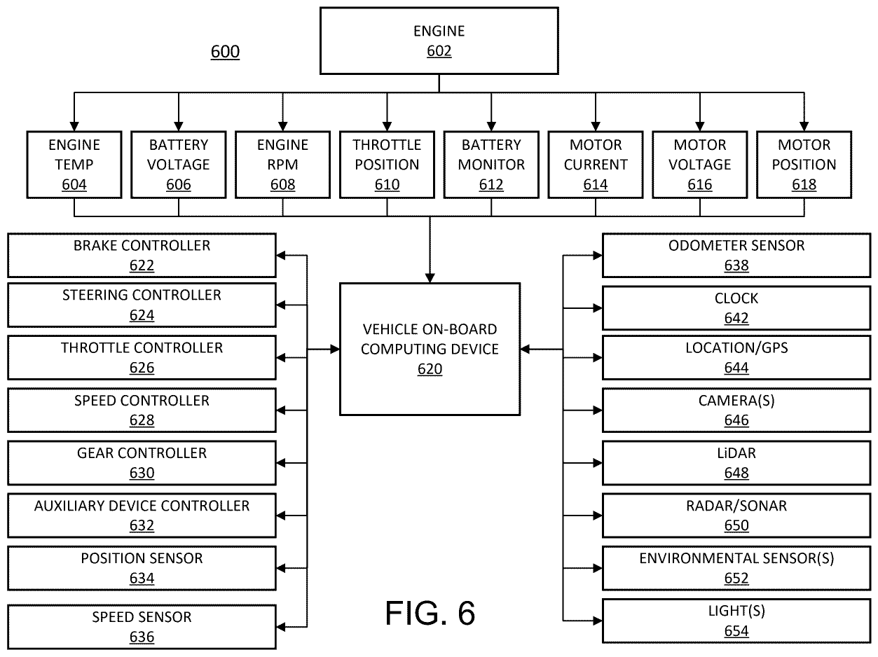

Referring now to FIG. 6, FIan example vehicle system architecture 600 for a vehicle is provided, in accordance with an exemplary embodiment of the present disclosure. The following discussion of vehicle system architecture 600 is sufficient for understanding one or more components of the vehicle described above.

As shown in FIG. 6, the vehicle system architecture 600 may comprise an engine, motor or propulsive device 602 and various sensors 604-618 for measuring various parameters of the vehicle system architecture 600, such as, but not limited to, those of the vehicle snapshot described above. In gas-powered or hybrid vehicles having a fuel-powered engine, the sensors 604-618 may comprise, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly may comprise sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit; a speed sensor 636; and/or an odometer sensor 638. The vehicle system architecture 600 also may comprise a clock 642 that the system uses to determine vehicle time and/or date during operation. The clock 642 may be encoded into the vehicle on-board computing device 620, it may be a separate device, or multiple clocks may be available.

The vehicle system architecture 600 may comprise various sensors that operate to gather information about the environment in which the vehicle is traveling. These sensors may comprise, for example: a location sensor 644 (for example, a Global Positioning System (GPS) device); object detection sensors such as one or more cameras 646; a LiDAR sensor system 648; and/or a radar and/or a sonar system 650. The sensors may comprise environmental sensors 652 such as, e.g., a humidity sensor, a precipitation sensor, a light sensor, and/or ambient temperature sensor. The object detection sensors may be configured to enable the vehicle system architecture 600 to detect objects that are within a given distance range of the vehicle in any direction, while the environmental sensors 652 may be configured to collect data about environmental conditions within the vehicle's area of travel. According to an exemplary embodiment, the vehicle system architecture 600 may comprise one or more lights 654 (e.g., headlights, flood lights, flashlights, etc.).

During operations, information may be communicated from the sensors to an on-board computing device 620 (e.g., computing device 700). The on-board computing device 620 may be configured to analyze the data captured by the sensors and/or data received from data providers and may be configured to optionally control operations of the vehicle system architecture 600 based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers. The brake controller 622 may comprise a pedal effort sensor, pedal effort sensor, and/or simulator temperature sensor, as described herein.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LiDAR 648 may be communicated from those sensors to the on-board computing device 620. The object detection information and/or captured images may be processed by the on-board computing device 620 to detect objects in proximity to the vehicle. Any known or to be known technique for making an object detection based on sensor data and/or captured images may be used in the embodiments disclosed in this document.

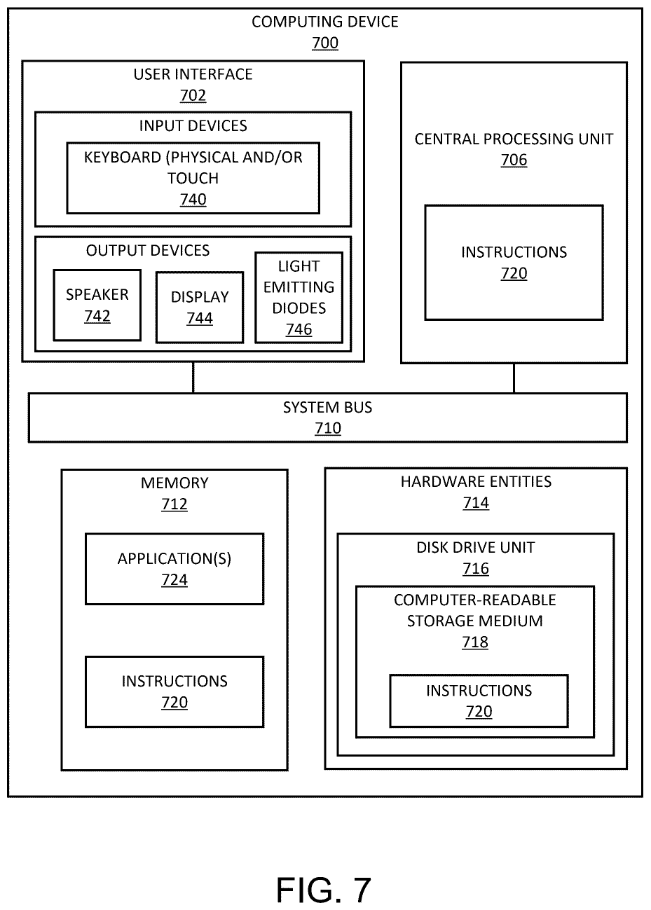

Referring now to FIG. 7, an illustration of an example architecture for a computing device 700 is provided. According to an exemplary embodiment, one or more functions of the present disclosure may be implemented by a computing device such as, e.g., computing device 700 or a computing device similar to computing device 700. Computing device 700 may be a quantum computer, a classical computer, and/or have one or more components configured to perform one or more quantum and/or classical computing functions. Computing device 620 and/or vehicle external communication apparatus 100 may be examples of computing device 700 and/or may comprise one or more components of computing device 700. According to an exemplary embodiment the location information generation unit 110, the control unit 120, the voice processing unit 130, and/or the voice output unit 140 may be components of the computing device 700.

The hardware architecture of FIG. 7 represents one example implementation of a representative computing device configured to implement at least a portion of the systems/devices and method(s)/control logic(s) described herein.

Some or all components of the computing device 700 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 7, the computing device 700 may comprise a user interface 702 (e.g., a graphical user interface), a Central Processing Unit (“CPU”) 706, a system bus 710, a memory 712 connected to and accessible by other portions of computing device 700 through system bus 710, and hardware entities 714 connected to system bus 710. The user interface may comprise input devices and output devices, which may be configured to facilitate user-software interactions for controlling operations of the computing device 700. The input devices may comprise, but are not limited to, a physical and/or touch keyboard 740. The input devices may be connected to the computing device 700 via a wired or wireless connection (e.g., a Bluetooth® connection). The output devices may comprise, but are not limited to, a speaker 742, a display 744, and/or light emitting diodes 746.

At least some of the hardware entities 714 may be configured to perform actions involving access to and use of memory 712, which may be a Random Access Memory (RAM), a disk driver and/or a Compact Disc Read Only Memory (CD-ROM), among other suitable memory types. Hardware entities 714 may comprise a disk drive unit 716 comprising a computer-readable storage medium 718 on which may be stored one or more sets of instructions 720 (e.g., programming instructions such as, but not limited to, software code) configured to implement one or more of the methodologies, procedures, or functions described herein. The instructions 720 may also reside, completely or at least partially, within the memory 712 and/or within the CPU 706 during execution thereof by the computing device 700.

The memory 712 and the CPU 706 may also constitute machine-readable media. The term “machine-readable media”, as used here, refers to a single medium or multiple media (e.g., a centralized or distributed database, and/or associated caches and servers) that store the one or more sets of instructions 720. The term “machine-readable media”, as used here, also refers to any medium that is capable of storing, encoding, or carrying a set of instructions 720 for execution by the computing device 700 and that cause the computing device 700 to perform any one or more of the methodologies of the present disclosure. According to various embodiments, one or more computer applications 724 may be stored on the memory 712.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present disclosure and its particular application and to thereby enable those skilled in the art to make and use embodiments of the disclosure. However, those skilled in the art will recognize that the foregoing description and examples have been presented for the purposes of illustration and example only. The description as set forth is not intended to be exhaustive or to limit the embodiments of the disclosure to the precise form disclosed.

What is claimed is:

1. An apparatus for vehicle external communication, comprising:
a processor configured to:
generate location information of a user through an external sensor of a vehicle;
control a window of the vehicle based on the location information of the user;
process respective voice signals transmitted from a plurality of microphones inside the vehicle based on the location information of the user; and
output a guidance voice through a speaker closest to the user among a plurality of speakers based on the location information of the user.

2. The apparatus according to claim 1, wherein the processor may be further configured to:
receive distance information between the vehicle and surrounding objects through an ultrasonic sensor;
capture an image of one or more of a front, a rear, a left side, or a right side of the vehicle through a camera;
detect the user based on the distance information and the image; and
generate location information of the user based on the distance information and the image, wherein the location information comprises a user's distance and direction relative to the vehicle, and the direction is one of a front-left, a front-right, a rear-left, or a rear-right of the vehicle.

3. The apparatus according to claim 2, wherein the processor may be further configured to:
detect a user area based on the distance information and the image through a single shot detector (SSD);
determine a confidence score for each of the detected user areas; and
determine the user based on the user area with a highest confidence score among user areas having confidence scores equal to or greater than a predetermined threshold.

4. The apparatus according to claim 1, wherein the processor may be further configured to:
control opening or closing of the window in the direction of the user through a body domain controller (BDC) based on a communication request signal of the user received through an in-vehicle infotainment (IVI) system connected to an external control server.

5. The apparatus according to claim 4, wherein the processor may be further configured to:
adjust an opening degree of the window in the direction of the user through the BDC based on the user's distance relative to the vehicle.

6. The apparatus according to claim 4, wherein the guidance voice comprises one or more of a hands-free sound output through a call connection with the external control server or a guidance voice of the IVI system output in response to the voice signal of the user.

7. The apparatus according to claim 4, wherein the processor may be further configured to:
close the window through the BDC;
capture an interior image of the vehicle through an interior camera via the IVI system; and
transmit the interior image of the vehicle to the external control server, based on one or more of a communication termination signal being received from a terminal of the user, a communication termination signal being received from the external control server, or the user not being determined.

8. The apparatus according to claim 1, wherein the processor may be further configured to:
adjust a beamforming region of the plurality of microphones to a region covering the user based on the location information of the user, and extract a voice signal corresponding to the beamforming region.

9. The apparatus according to claim 1, wherein the processor may be further configured to:
perform one or more of noise suppression, auto gain control (AGC), equalization, or digital filtering on a voice signal of the user.

10. The apparatus according to claim 1, wherein the processor may be further configured to:
set a gain value of an external amplifier based on the user's distance relative to the vehicle.

11. A system for vehicle external communication, comprising:
a vehicle; and
a computing device, coupled to the vehicle, wherein:
the computing device comprises a processor and a memory, and
the memory is configured to store instructions that, when executed by the processor, are configured to cause the processor to:
generate location information of a user through an external sensor of the vehicle;
control a window of the vehicle based on the location information of the user;
process respective voice signals transmitted from a plurality of microphones inside the vehicle based on the location information of the user; and
output a guidance voice through a speaker closest to the user among a plurality of speakers based on the location information of the user.

12. A method for vehicle external communication, comprising:
using a computing device, coupled to a vehicle, comprising a processor and a memory:
generating location information of a user through an external sensor of the vehicle;
controlling a window of the vehicle based on the location information of the user;
processing respective voice signals transmitted from a plurality of microphones inside the vehicle based on the location information of the user; and
outputting a guidance voice through a speaker closest to the user among a plurality of speakers based on the location information of the user.

13. The method according to claim 12, wherein the generating the location information of the user comprises:
receiving distance information between the vehicle and surrounding objects through an ultrasonic sensor;
capturing an image of one or more of a front, a rear, a left side, or a right side of the vehicle through a camera;
detecting the user based on the distance information and the image; and
generating the location information of the user based on the distance information and the image, wherein the location information comprises a user's distance and direction relative to the vehicle, and the direction is one of a front-left, a front-right, a rear-left, or a rear-right of the vehicle.

14. The method according to claim 13, wherein the generating the location information comprises detecting a user area based on the distance information and the image through a single shot detector (SSD), determining a confidence score for each of the detected user areas,
and determining the user based on the user area with a highest confidence score among user areas having confidence scores equal to or greater than a predetermined threshold.

15. The method according to claim 12, wherein the controlling comprises controlling opening or closing of the window in the direction of the user through a body domain controller (BDC) based on a communication request signal of the user received from in-vehicle infotainment (IVI) system connected to an external control server.

16. The method according to claim 15, wherein the controlling comprises:
adjusting an opening degree of the window in the direction of the user through the BDC based on the user's distance relative to the vehicle; or
closing the window through the BDC, capturing an interior image of the vehicle through an interior camera via the IVI system, and transmitting the interior image of the vehicle to the external control server, based on one or more of a communication termination signal being received from a terminal of the user, a communication termination signal being received from the external control server, or the user not being determined.

17. The method according to claim 15, wherein the guidance voice comprises one or more of a hands-free sound output through a call connection with the external control server or a guidance voice of the IVI system output in response to the voice signal of the user.

18. The method according to claim 12, further comprising:
adjusting a beamforming region of the plurality of microphones to a region covering the user based on the location information of the user; and
extracting a voice signal corresponding to the adjusted beamforming region.

19. The method according to claim 12, wherein the extracting the voice signal comprises performing one or more of noise suppression, auto gain control (AGC), equalization, or digital filtering on a voice signal of the user.

20. The method according to claim 12, wherein the outputting the guidance voice comprises setting a gain value of an external amplifier based on the user's distance relative to the vehicle.
